(19) United States
(12) Patent Application Publication
(10) Pub. No.: US 2021/0221153 A1
(43) Pub. Date: Jul. 22, 2021

(54) LIQUID DISCHARGE APPARATUS

(71) Applicant: Takeshi SEKIKAWA, Kanagawa (JP)

(72) Inventor: Takeshi SEKIKAWA, Kanagawa (JP)

(21) Appl. No.: 17/136,187

(22) Filed: Dec. 29, 2020

(30) Foreign Application Priority Data
Jan. 21, 2020 (JP) 2020-007740

(51) Int. Cl. B41J 25/00

(52) U.S. Cl. CPC B41J 25/001

(57) ABSTRACT

A liquid discharge apparatus includes a liquid discharge head, a carriage mounted with the liquid discharge head, a tubular member connected to the carriage, and a holder to hold one end of the tubular member. The carriage reciprocates and scans in a main scanning direction, and includes a first area opposed to one end of the holder in a main scanning direction and a second area opposed to another end of the holder in the main scanning direction. The holder is scanned in conjunction with scanning of the carriage without being fixed to the carriage.

### CROSS-REFERENCE TO RELATED APPLICATION

This patent application is based on and claims priority pursuant to 35 U.S.C. § 119(a) to Japanese Patent Application No. 2020-007740, filed on Jan. 21, 2020, in the Japan Patent Office, the entire disclosure of which is incorporated by reference herein.

### BACKGROUND

### Technical Field

Aspects of the present disclosure relate to a liquid discharge apparatus.

### Related Art

In an inkjet-type image forming apparatus, a carriage having a liquid discharge head scans above a printing medium and discharges ink to form an image on the printing medium.

### SUMMARY

In an aspect of the present disclosure, there is provided a liquid discharge apparatus that includes a liquid discharge head, a carriage mounted with the liquid discharge head, a tubular member connected to the carriage, and a holder to hold one end of the tubular member. The carriage reciprocates and scans in a main scanning direction, and includes a first area opposed to one end of the holder in a main scanning direction and a second area opposed to another end of the holder in the main scanning direction. The holder is scanned in conjunction with scanning of the carriage without being fixed to the carriage.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a perspective view of a liquid discharge apparatus according to an embodiment of the present disclosure;

FIG. 2 is a schematic plan view of a carriage scanning mechanical section of the liquid discharge apparatus of FIG. 1;

FIG. 3 is a schematic front view illustrating the liquid discharge apparatus of FIG. 1;

FIG. 4 is a schematic side view illustrating the liquid discharge apparatus of FIG. 1;

FIG. 5 is a perspective view illustrating an example of a carriage;

FIG. 6 is a perspective view illustrating an example of a guide rod;

FIG. 7 is a schematic main top view illustrating an example of a connecting portion of a cable carrier;

FIG. 8 is a schematic front view illustrating an example of scanning of the carriage;

FIG. 9 is another schematic front view illustrating the example of the scanning of the carriage of FIG. 8;

FIG. 10 is still another schematic front view illustrating the example of the scanning of the carriage of FIG. 8;

FIG. 11 is a schematic front view illustrating an example of the cable carrier; and

FIG. 12 is a schematic front view illustrating another example of L-shaped brackets.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

A liquid discharge apparatus according to an embodiment of the present disclosure includes a liquid discharge head, a carriage mounted with the liquid discharge head, a tubular member connected to the carriage, and a holder to hold one end of the tubular member. The carriage reciprocates and scans in a main scanning direction, and includes a first area opposed to one end of the holder in a main scanning direction and a second area opposed to another end of the holder in the main scanning direction. The holder is scanned in conjunction with scanning of the carriage without being fixed to the carriage.

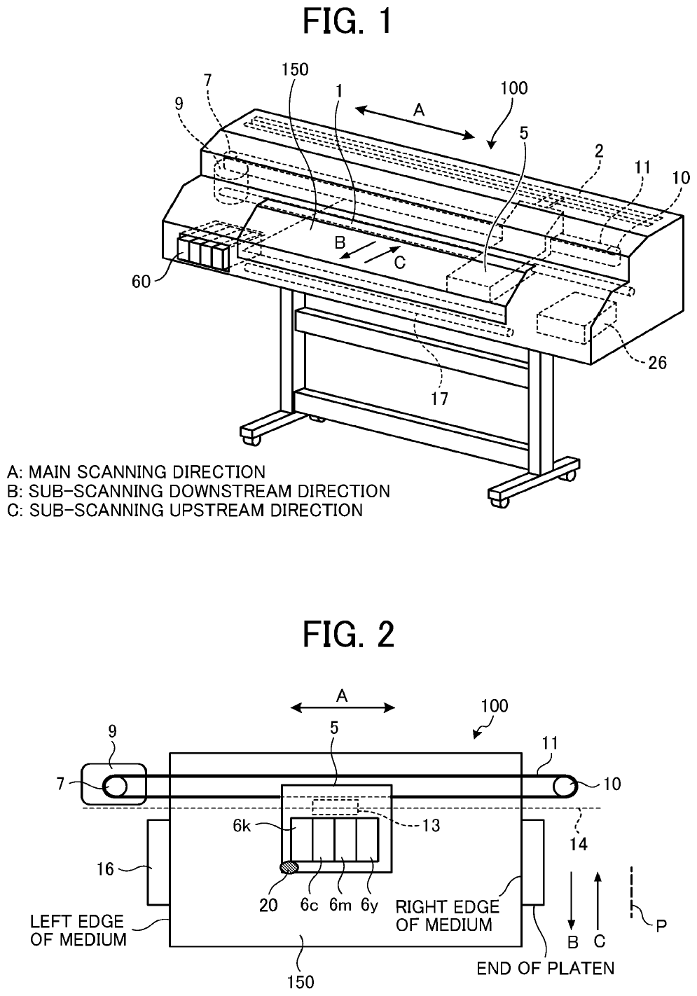

A liquid discharge apparatus according to an embodiment of the present disclosure is described below. FIG. 1 is an external perspective view of a liquid discharge apparatus 100 according to the present embodiment. FIG. 2 is a schematic plan view of a carriage scanning mechanical section of the liquid discharge apparatus 100 of FIG. 1. As illustrated in FIGS. 1 and 2, a guide rod 1 and a sub guide rail 2 are laid across both side plates inside the liquid discharge apparatus 100, and on the guide rod 1 and the sub guide rail 2a, a carriage 5 is movably held in the direction of arrow A (main scanning direction) in FIG. 1.

The carriage 5 is connected to a timing belt 11 wound around a drive pulley 7 and a pressure pulley 10 (see FIG. 2). The timing belt 11 is driven by a main scanning motor 9 via the drive pulley 7, and the carriage 5 is moved reciprocally in the main scanning direction A.

The timing belt 11 is tightened by the pressure pulley 10 and can drive the carriage 5 without sagging. A home position (HP) indicated by a broken line “P” is set above a maintenance mechanism 26, for example.

A printing medium 150 is intermittently conveyed in the direction of arrow B (sub-scanning direction) below the carriage 5 which reciprocates. Recording heads 6k, 6c, 6m, and 6y (serving as liquid discharge heads), mounted on the carriage 5 above a platen 16, discharge ink as droplets to form an image. That is, a plurality of nozzles is provided in the recording heads 6k, 6c, 6m, and 6y, and the ink is discharged from the nozzles to form the image.

The printing medium 150, on which the image has been formed, is dried by a drying unit 17, which is a drying heater, in a sheet ejection guide. Further, the liquid discharge apparatus 100 includes cartridges 60 that supply ink to the recording heads 6k, 6c, 6m, and 6y and a maintenance mechanism 26 that performs maintenance of the recording head 6k, 6c, 6m, and 6y mounted on the carriage 5. An encoder sensor 13 is disposed in the carriage 5. The encoder sensor 13 sequentially reads an encoder sheet 14 laid across both side plates and is driven between the side plates while detecting in the main scanning direction.

Further, a medium detection sensor 20, for example, a reflection-type sensor is attached to the carriage 5. The medium detection sensor 20 detects the reflected light emitted by a light emitting diode (LED) to detect the presence or absence of an object below the carriage 5. In the present embodiment, the medium detection sensor 20 identifies an outer area of the platen 16, an upper area of the platen 16, and upper area of the printing medium 150 directly below the carriage 5, according to the value of the reflected light.

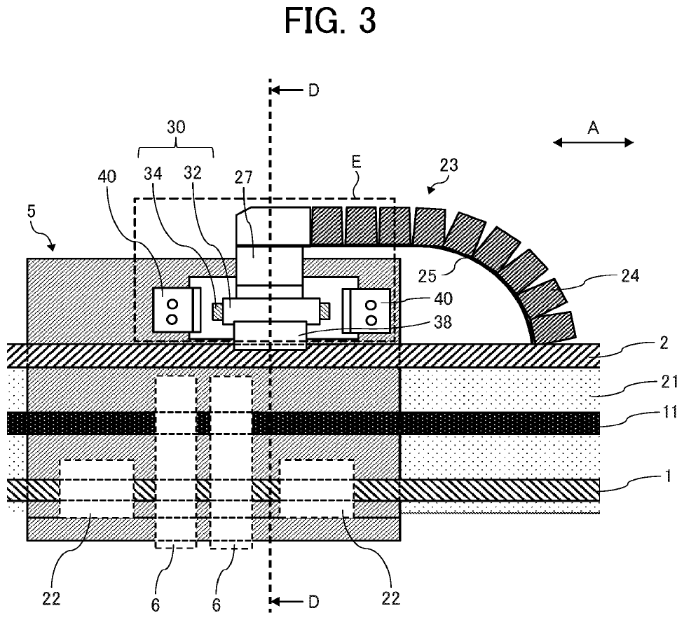

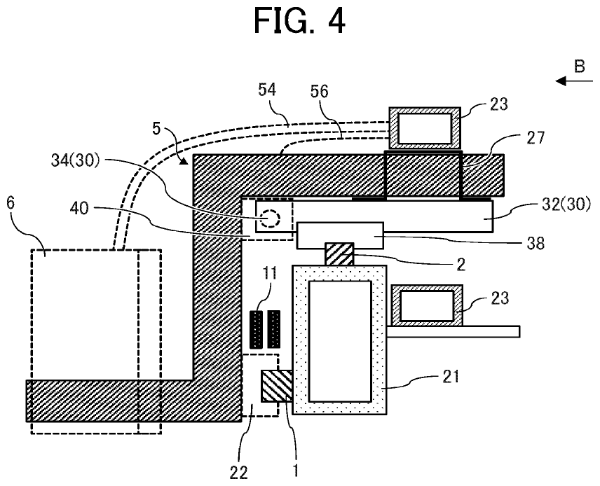

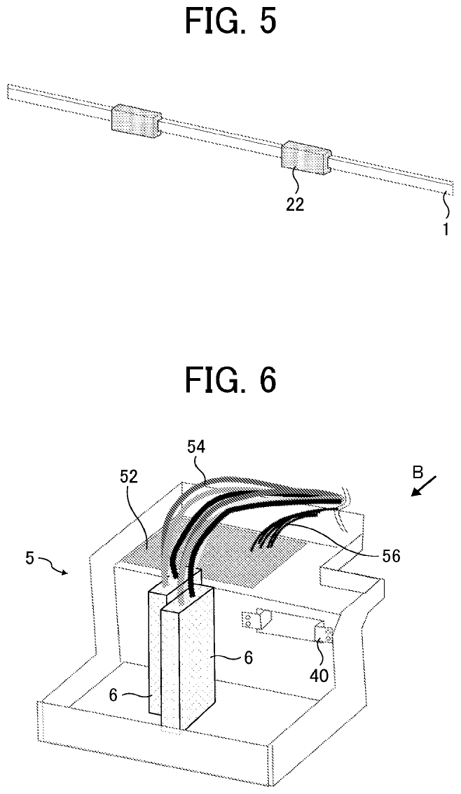

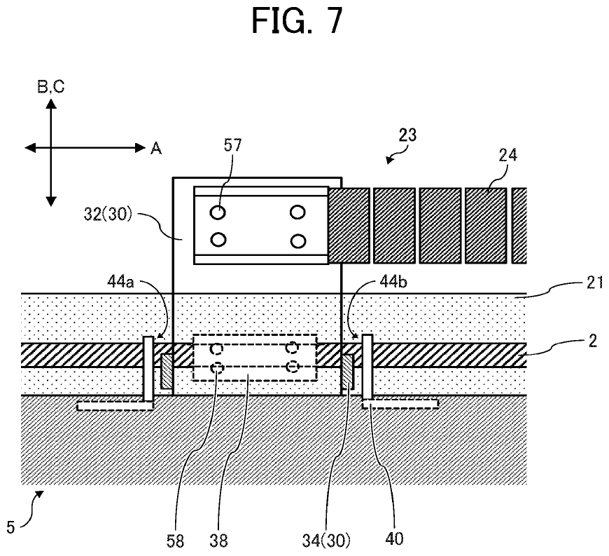

The liquid discharge apparatus according to the present embodiment is further described with reference to FIGS. 3 to 7. FIG. 3 is a schematic front view of the liquid discharge apparatus according to the present embodiment. FIG. 3 is a schematic view of the liquid discharge apparatus when viewed from the direction of arrow B in FIG. 1. FIG. 4 is a schematic side view of the liquid discharge apparatus according to the present embodiment, and a schematic cross-sectional view cut along line D-D in FIG. 3. FIG. 5 is a perspective view illustrating an example of the carriage. FIG. 6 is a perspective view illustrating an example of a guide rod. FIG. 7 is a schematic top view of an example of the connecting portion of a cable carrier.

The liquid discharge apparatus 100 according to the present embodiment has a recording head 6 (serving as a liquid discharge head), the carriage 5 that reciprocates and scans, a tube 54 and a cable 56 (serving as a tubular member) connected to the carriage 5, and a cable carrier base 30 (serving as a holder) that holds one end of the tubular member. Further, in the present embodiment, the liquid discharge apparatus may include a cable carrier 23 (serving as a surrounding member) formed along the tubular member so as to surround at least a portion of the tubular member.

In FIG. 3, a main scanning stay 21 is illustrated, and the main scanning stay 21 includes the guide rod 1 for supporting the carriage 5 and the sub guide rail 2 for supporting the holder. The guide rod 1 is provided with a guide rod block 22, and the guide rod block 22 slides along the guide rod 1. A ball, for example, is provided inside the guide rod block 22 so that the guide rod block 22 can be smoothly slid against the guide rod 1.

The carriage 5 is attached to the guide rod 1 via the guide rod block 22 and is supported by its own weight. The carriage 5 includes the recording head 6. Liquid (e.g., ink) is discharged from the recording head 6 while the carriage 5 reciprocates along the guide rod 1. The number and arrangement of the recording head 6 can be appropriately changed.

The carriage 5 is connected to the tube 54, the cable 56, and so forth. The ink can be supplied to the recording head 6 through the tube 54. The number of the tube 54 can be appropriately changed. Further, the carriage 5 is provided with a control board 52, and the cable 56 for control can be connected to the control board 52. The cable 56 may be used to control the discharge of the recording head 6, for example.

The tube 54 and the cable 56 may be disposed inside the cable carrier 23. The cable carrier 23 includes, for example, a cavity-member support member 25, an end member 27, and a plurality of cavity members 24. The cable carrier 23, as illustrated in, e.g., FIG. 4, has a cavity inside.

One end of the cable carrier 23 is held on the cable carrier base 30. How the end of the cable carrier 23 is held on the cable carrier base 30 can be appropriately changed. For example, the end member 27 is joined to the cable carrier base 30 and is held on the cable carrier base 30.

The shape of the end member 27 can be appropriately changed. For example, the shape illustrated in FIG. 4 may be selected.

Although not particularly limited, the other end of the cable carrier 23 may be located on the vicinity (e.g., side face) of the main scanning stay 21, as illustrated in, e.g., FIG. 4.

The sub guide rail 2 is provided with a sub guide rail block 38, and the sub guide rail block 38 slides along the sub guide rail 2. As in the guide rod block 22, for example, a ball is provided in the sub guide rail block 38, and the ball can be smoothly slid against the sub guide rail 2.

The cable carrier base 30 is attached to the sub guide rail 2 via the sub guide rail block 38. Therefore, the cable carrier 23 is supported by the sub guide rail 2.

In FIG. 7, an example of the connecting portion of the cable carrier 23 is illustrated. For example, the cable carrier 23 or the cable carrier base 30 has a mounting hole 57, and the cable carrier 23 and the cable carrier base 30 can be connected by the mounting hole 57. Further, for example, the cable carrier base 30 or the sub guide rail block 38 has a mounting hole 58, and the cable carrier base 30 and the sub guide rail block 38 can be connected by the mounting hole 58.

As illustrated in FIG. 7, the cable carrier base 30 is not fixed to the carriage 5 and is disposed independently. In the example illustrated in FIG. 7, the cable carrier base 30 is not fixed to the carriage 5 on the one end and the other end in the main scanning direction and the sub-scanning direction.

The carriage 5 has areas opposed to one end and another end of the cable carrier base 30 in the main scanning direction. In the present embodiment, the above-described area may be referred to as “opposing area”. Two opposing areas are present at one end and the other end and are distinguished by being referred to as, for example, one opposing area and the other opposing area. When “opposing areas” are simply referred to as, the term “opposing areas” means two opposing areas.

In the present embodiment, L-shaped brackets 40 are provided in the opposing areas. However, the configuration of the opposing areas is not limited to such a configuration. Other members may be provided in the opposing areas, or the L-shaped brackets 40 may not be provided in the opposing areas.

The opposing areas are illustrated as reference numerals 44a and 44b in FIG. 7. However, the reference numerals 44a and 44b may be omitted in other drawings. The carriage 5 in the present embodiment, for example, has the opposing areas in the areas on which the L-shaped brackets 40 are provided.

Since the carriage 5 has the opposing areas, one end of the cable carrier base 30 and one opposing area of the carriage 5 collide with each other in the main scanning direction when the carriage 5 scans. As a result, the cable carrier base 30 can be scanned in conjunction with the carriage 5. The carriage 5 of the present embodiment performs a reciprocating operation. Since the carriage 5 has two opposing areas in the main scanning direction, the cable carrier base 30 and the carriage 5 can be scanned in conjunction with each other in both forward scanning and return scanning.

The vibration of the carriage 5 is largely affected by addition of vibrations of cables 56 (see FIG. 6) connected from the main body of the liquid discharge apparatus 100 to the carriage 5. In contrast, in the present embodiment, the cable carrier base 30 is scanned in conjunction with the carriage 5 without being fixed to the carriage 5, when the carriage 5 is scanned. Such a configuration can prevent the vibration of the cable carrier 23 from being transmitted to the carriage 5 via the cable carrier base 30. As a result, the landing positions of ink can be prevented from shifting due to the vibration of the carriage 5 by disturbances.

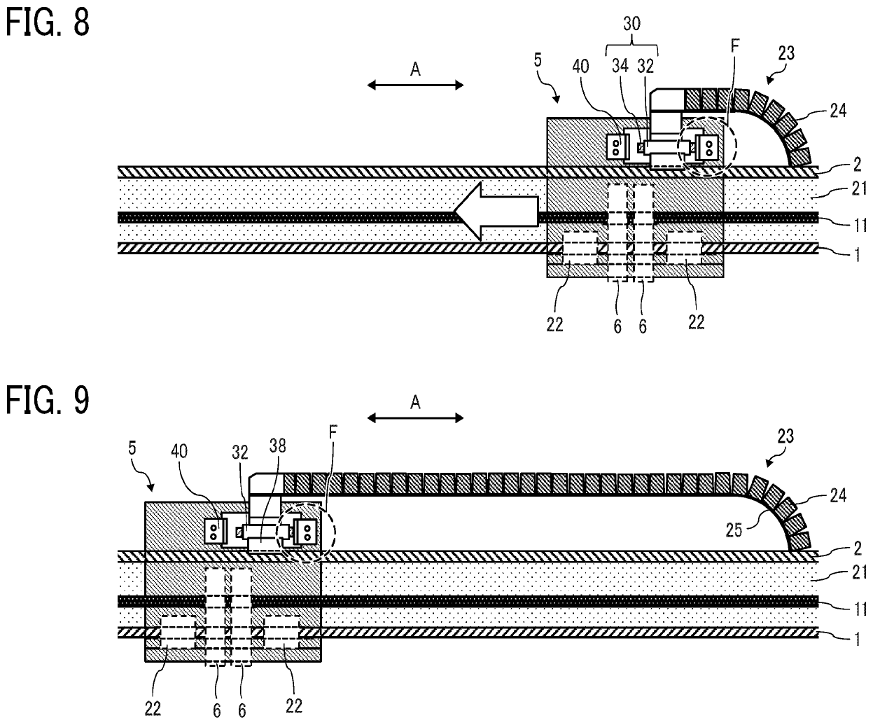

An example of the reciprocating operation of the carriage 5 in the present embodiment is described with reference to FIGS. 8 to 11. FIG. 8 is a schematic front view illustrating an example of the scanning of the carriage 5 and is a view illustrating a case of the forward scanning. The carriage 5 is scanned in the direction indicated by a thick arrow in FIG. 8. The timing belt 11 is pulled by the main scanning motor 9 and so forth, and the carriage 5 moves in the direction indicated by the thick arrow in FIG. 8. At this time, the cable carrier base 30 collides with the carriage 5, as illustrated by a broken line F in FIG. 8. As a result, the cable carrier base 30 moves in conjunction with the carriage 5.

In the present embodiment, as illustrated in FIG. 8, the sliding member 34 of the cable carrier base 30 collides with the L-shaped bracket 40 of the carriage 5.

FIG. 9 is a schematic view illustrating an example in which the carriage 5 has reached a turning position of a reciprocating operation of the carriage 5. As illustrated in the broken line F, the cable carrier base 30 collides with the carriage 5 at the same position as in FIG. 9.

When the carriage 5 has reached the turning position, the cable carrier base 30 collides with the carriage 5 due to inertia at the opposite position to the position illustrated in FIG. 8, and the carriage 5 may be shocked. However, the effect on the image can be prevented by, for example, not discharging ink at the turning position.

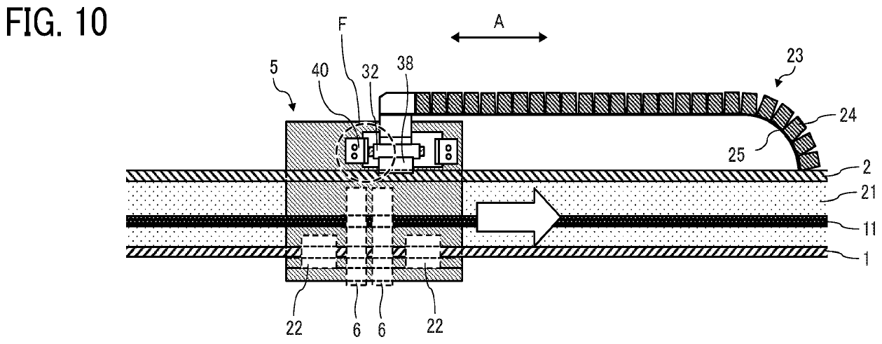

As illustrated in FIG. 10, as the cable carrier base 30 moves in conjunction with the carriage 5, the shape of the cable carrier 23 changes. Although not limited to above-described configuration, the cavity members 24 are rolled out, and the cable carrier 23 preferably changes the shape so as to extend in the moving direction of the carriage 5. Such a configuration can prevent the linearity of the carriage 5 from being hampered. In this case, it is preferable that the cable carrier 23 is changed into a desired shape by using, for example, the cavity-member support member 25.

FIG. 10 is a schematic view illustrating return scanning of the carriage 5 in a reciprocating operation. As illustrated in the broken line F in FIG. 10, the cable carrier base 30 collides with the carriage 5 at the opposite position to the position illustrated in FIG. 8 and moves.

In the case of return scanning, it is preferable that the shape of the cable carrier 23 changes so as to return to the original state. That is, it is preferable that the cavity members 24 are rolled back and the shape of the cable carrier 23 changes so as to return to the state illustrated in FIG. 10. In other words, it can be said that the cable carrier 23 shrinks in the moving direction of the carriage 5. Such a configuration can prevent the movement of the carriage 5 from being hampered can enhance the linearity of the carriage 5.

According to the present embodiment, vibration can be prevented from being transmitted to the carriage 5 through the cable carrier base 30 holding the cables 56 (see FIG. 6), and a good image can be obtained. Further, separating the cable carrier base 30 of the cables 56 (see FIG. 6) from the carriage 5 can enhance the linearity of the carriage 5.

According to the present embodiment, the cable carrier base 30 (serving as the holder) is disposed so that both ends of the cable carrier base 30 in the main scanning direction are sandwiched between a portion of the carriage 5 while having a gap with the carriage 5. The cable carrier base 30 is dragged and moved by the carriage 5. Thus, the stress of the holder is prevented from being transmitted to the carriage 5, and the addition of vibration to the carriage 5 can be restrained.

As illustrated in FIG. 7, it is preferable that one end and the other end of the cable carrier base 30 in the main scanning direction and the sub-scanning direction are not fixed to the carriage 5. Such a configuration can easily secure a state in which the carriage 5 and the cable carrier base 30 are independent from each other, thus further preventing the carriage 5 from vibrating due to disturbance.

In the present embodiment, the cable carrier base 30 has sliding members 34 at one end and the other end in the main scanning direction. The sliding member 34 can further prevent the vibration of the cable carrier base 30 from being transmitted to the carriage 5.

As described above, when the carriage 5 is scanned, the cable carrier base 30 and the carriage 5 come into contact with each other. However, the sliding member 34 can reduce the friction between the cable carrier base 30 and the carriage 5. To reduce the friction, a frictional coefficient may be adjusted, for example, as described below, or the contact area of the sliding member 34 and the carriage 5 may be adjusted.

In the present embodiment, the cable carrier base 30 includes the sliding member 34 and a holder main body 32 provided with the sliding member 34. The sliding member 34 can be appropriately changed. However, it is preferable that the frictional coefficient of the sliding member 34 is lower than the frictional coefficient of the holder main body 32. In this case, when the sliding member 34 comes into contact with the carriage 5, the sliding member 34 slides freely relative to the carriage 5, so that the frictional force of the cable carrier base 30 and the carriage 5 can be reduced. Such a configuration can further prevent the vibration of the cable carrier base 30 from being transmitted to the carriage 5.

In the present embodiment, the carriage 5 includes the L-shaped bracket 40 (serving as the L-shaped member) arranged on at least one of the two areas that facing one end and the other end of the cable carrier base 30 in the main scanning direction. Use of the L-shaped bracket 40 can adjust a member so as to reduce the friction between the cable carrier base 30 and carriage 5. Further, the size of a gap between the carriage 5 and the cable carrier base 30 can be adjusted as described below.

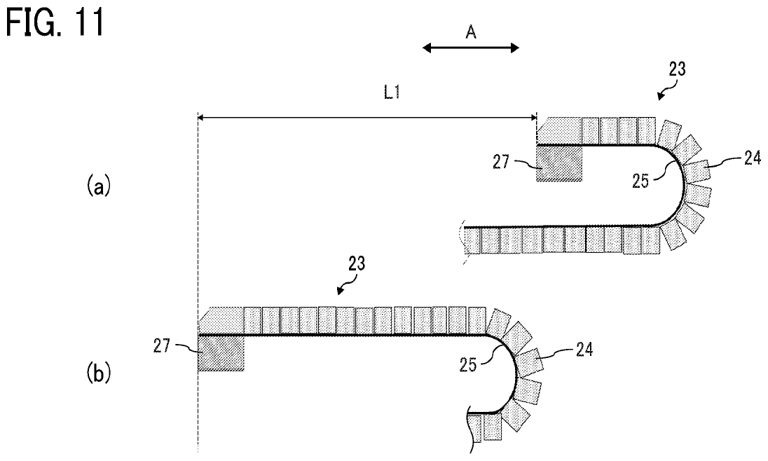

The cable carrier 23 (surrounding member) in the present embodiment is described with reference to FIG. 11. FIG. 11 is a schematic front view illustrating an example of the cable carrier 23 and a schematically view of the cable carrier 23 of FIG. 3.

As described in FIGS. 8 to 10, in the present embodiment, it is preferable that the shape of the cable carrier 23 can be changed so as to extend and shrink in the main scanning direction. Such a configuration allows the cables 56 to be connected to the carriage 5 without hampering the linearity of the carriage 5.

Part (a) of FIG. 11 illustrates a state of the cable carrier 23 in which the carriage 5 is at a point, and corresponds to the state of FIG. 8, for example. Part (b) of FIG. 11 illustrates another state of the cable carrier 23 in which the carriage 5 is scanned to another point, and corresponds to the state of FIG. 9, for example.

The cable carrier 23 in the present embodiment has a cavity inside, and the tubes 54, the cables 56, and so forth, can be stored inside the cavity. Storing the tubes 54, the cables 56, and so forth inside the cable carrier 23 allows the linearity of the carriage 5 to be enhanced without hampering the linearity of the carriage 5.

The cable carrier 23 in the present embodiment has the plurality of cavity members 24 having cavities inside, and the cavity members 24 are connected in a chain-shape, for example. Note that the cavity member is also referred to as a frame member.

The plurality of cavity members 24 allows the tubes 54, the cables 56, and so forth, to be guided even when the stroke of movement of the carriage 5 is long, for example, as illustrated as L1 in FIG. 11. Such a configuration can keep the shape as illustrated in FIG. 11 and prevent the tubes 54 and the cables 56 from being bent in the direction in which the scanning of the carriage 5 is hampered.

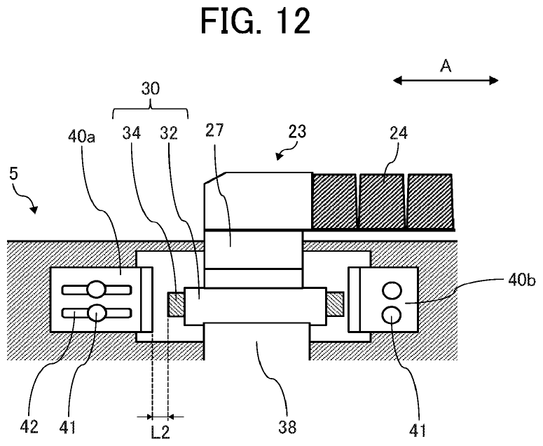

Another example of the arrangement of the L-shaped bracket 40 (L-shaped member) is described with reference to FIG. 12. FIG. 12 is a schematic view illustrating the arrangement of L-shaped brackets 40 in the present embodiment and is a schematic view corresponding to the area of E in FIG. 3.

In the present embodiment, a mechanism that can adjust the distance L2 between the cable carrier base 30 and the carriage 5 is disposed. For example, an L-shaped bracket 40a has mounting holes 42 that are long holes. Since the mounting holes 42 are long holes, the locking positions of locking members 41 can be appropriately changed, and the distance L2 between the cable carrier base 30 and the carriage 5 can be adjusted.

In the present embodiment, without fixing the one end and the other end of the cable carrier base 30 in the main scanning direction to the carriage 5, the cable carrier base 30 is scanned in conjunction with the carriage 5 when the carriage 5 is scanned. At this time, the vibration of the cable carrier base 30 is difficult to be transmitted to the carriage 5. However, due to the gap between the cable carrier base 30 and the carriage 5, the carriage 5 may be shocked from the cable carrier base 30 when the carriage 5 is returned.

On the other hand, according to the present embodiment, the distance L2 between the cable carrier base 30 and the carriage 5 can be adjusted, for example, so that the distance L2 is as small as possible. As a result, the carriage 5 can lessen the shock from the cable carrier base 30 when the carriage 5 is returned.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A liquid discharge apparatus comprising:
a liquid discharge head;
a carriage mounted with the liquid discharge head, the carriage being configured to reciprocate and scan in a main scanning direction;
a tubular member connected to the carriage; and
a holder configured to hold one end of the tubular member, the carriage including:
a first area opposed to one end of the holder in a main scanning direction; and
a second area opposed to another end of the holder in the main scanning direction,
the holder being configured to be scanned in conjunction with scanning of the carriage without being fixed to the carriage.

2. The liquid discharge apparatus according to claim 1,
wherein the one end and said another end of the holder in the main scanning direction is not fixed to the carriage, and
wherein one end and another end of the holder in a sub-scanning direction orthogonal to the main scanning direction is not fixed to the carriage.

3. The liquid discharge apparatus according to claim 1,
wherein the holder includes a plurality of sliding members at the one end and said another end in the main scanning direction.

4. The liquid discharge apparatus according to claim 3,
wherein the holder includes the plurality of sliding members and a holder main body, and
wherein a frictional coefficient of each of the plurality of sliding members relative to the carriage is lower than a frictional coefficient of the holder main body relative to the carriage.

5. The liquid discharge apparatus according to claim 1,
wherein the carriage includes an L-shaped member in at least one of the first area and the second area opposed to the one end and said another end, respectively, of the holder in the main scanning direction.

6. The liquid discharge apparatus according to claim 5,
wherein the L-shaped member is configured to be adjustable with respect to a distance between the L-shaped member and the holder while the carriage is stationary.

7. The liquid discharge apparatus according to claim 1,
wherein the tubular member is one of a control cable and a tube connected to the liquid discharge head.

8. The liquid discharge apparatus according to claim 1, further comprising a surrounding member surrounding, along the tubular member, at least a portion of the tubular member.

9. The liquid discharge apparatus according to claim 8,
wherein the surrounding member includes a plurality of cavity members having cavities inside, and the tubular member is disposed inside the plurality of cavity members.
